(19) United States
(12) Patent Application Publication
(10) Pub. No.: US 2019/0370559 A1
(43) Pub. Date: Dec. 5, 2019

(54) AUTO-SEGMENTATION WITH RULE ASSIGNMENT

(71) Applicant: WIZR LLC, Santa Monica, CA (US)

(72) Inventors: David CARTER, Marina del Rey, CA (US); Genquan DUAN, Los Angeles, CA (US); Andrew PIERNO, Santa Monica, CA (US); Daniel MAZZELLA, Los Angeles, CA (US)

(73) Assignee: WIZR LLC, Santa Monica, CA (US)

(21) Appl. No.: 16/408,235

(22) Filed: May 9, 2019

Related U.S. Application Data
(60) Provisional application No. 62/668,922, filed on May 9, 2018.

(51) Int. Cl. G06K 9/00; G06N 5/04

(52) U.S. Cl. CPC G06K 9/00765; G06K 9/00718; G06K 2009/00738; G06N 5/04; G06K 9/00771

(57) ABSTRACT

Segments are generated with respect to images and rules are correlated to the segments. The images may be associated with the field of view of a camera that is used in systems having artificial intelligence engines in connection with video cameras and associated video data streams. A video processor identifies element in a video stream, examples of which include various regions in a view, such as sky, vegetation, buildings, etc. The elements may be identified based on elements that were previously identified for other cameras and can be updated in response to the view changing. Segments are created around the different identified elements. Rules are assigned to the segments. The rules and segments may be stored for later reference when analyzing events within the view of the video camera.

### BRIEF DESCRIPTION OF THE FIGURES

These and other features, aspects, and advantages of the present disclosure are better understood when the following Detailed Description is read with reference to the accompanying drawings.

FIG. 1 illustrates a block diagram of a system 100 for auto-segmenting a video feed and assigning rules to each segment.

FIGS. 2a-2d are example depictions of auto-segmented video feeds according to some embodiments.

FIG. 3 is a flowchart of an example process for auto-segmenting a video feed and assigning rules according to some embodiments.

FIG. 4 shows an illustrative computational system for performing functionality to facilitate implementation of embodiments described herein.

### DETAILED DESCRIPTION

Systems and methods are disclosed for auto-segmenting a video feed. Systems and methods are also disclosed for assigning rules to each segment of the video feed.

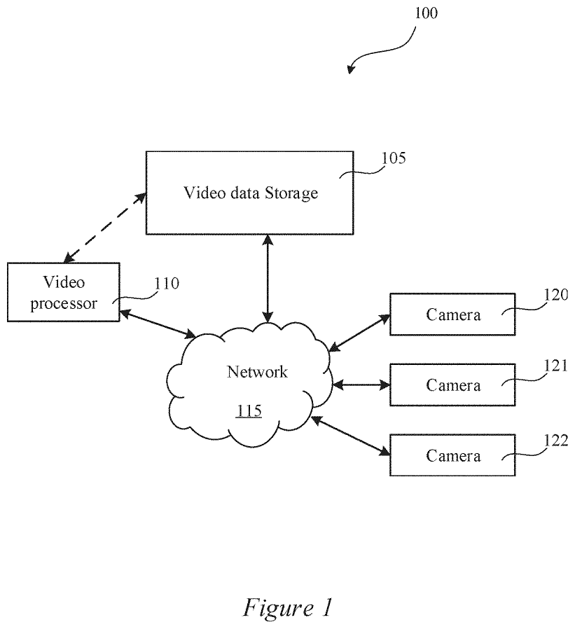

FIG. 1 illustrates a block diagram of a system 100 that may be used in various embodiments. The system 100 may include a plurality of cameras: camera 120, camera 121, and camera 122. While three cameras are shown, any number of cameras may be included. These cameras may include any type of video camera such as, for example, a wireless video camera, a black and white video camera, surveillance video camera, portable cameras, battery powered cameras, CCTV cameras, Wi-Fi enabled cameras, smartphones, smart devices, tablets, computers, GoPro cameras, wearable cameras, satellite cameras, etc. The cameras may be positioned anywhere. For example, in some embodiments, the cameras may be positioned within the same geographic location, in separate geographic locations, positioned to record portions of the same scene, positioned to record different portions of the same scene, etc. In some embodiments, the cameras may be associated with robots. In some embodiments, the robots may include artificial intelligence to perform tasks. In some embodiments, the cameras may be owned and/or operated by different users, organizations, companies, entities, etc.

The cameras may be coupled with the network 115. The network 115 may, for example, include the Internet, a telephonic network, a wireless telephone network, a 3G network, etc. In some embodiments, the network may include multiple networks, connections, servers, switches, routers, connections, etc. that may enable the transfer of data. In some embodiments, the network 115 may be or may include the Internet. In some embodiments, the network may include one or more LAN, WAN, WLAN, MAN, SAN, PAN, EPN, and/or VPN.

In some embodiments, one more of the cameras may be coupled with a base station, digital video recorder, or a controller that is then coupled with the network 115.

The system 100 may also include video data storage 105 and/or a video processor 110. In some embodiments, the video data storage 105 and the video processor 110 may be coupled together via a dedicated communication channel that is separate from or part of the network 115. In some embodiments, the video data storage 105 and the video processor 110 may share data via the network 115. In some embodiments, the video data storage 105 and the video processor 110 may be part of the same system or systems.

In some embodiments, the video data storage 105 may include one or more remote and/or local data storage locations such as, for example, a cloud storage location, a remote storage location, etc.

In some embodiments, the video data storage 105 may store video files recorded by one or more of camera 120, camera 121, and camera 122. In some embodiments, the video files may be stored in any video format such as, for example, mpeg, avi, etc. In some embodiments, video files from the cameras may be transferred to the video data storage 105 using any data transfer protocol such as, for example, HTTP live streaming (HLS), real time streaming protocol (RTSP), Real Time Messaging Protocol (RTMP), HTTP Dynamic Streaming (HDS), Smooth Streaming, Dynamic Streaming over HTTP, HTML5, Shoutcast, etc.

In some embodiments, the video data storage 105 may store user identified event data reported by one or more individuals. The user identified event data may be used, for example, to train the video processor 110 to capture feature events. In some embodiments, the video data storage 105 may store rule conditions and/or rule responses created by one or more users and/or one or more providers of the camera 120, the camera 121, and/or the camera 122. The rule conditions and rule responses may be used, for example, to correlate the video stream segments with the rule conditions and rule responses.

In some embodiments, a video file may be recorded and stored in memory located at a user location prior to being transmitted to the video data storage 105. In some embodiments, a video file may be recorded by the camera and streamed directly to the video data storage 105. Additionally or alternatively, in some embodiments, a video file may be recorded by the camera, and streamed or saved on any number of intermediary servers and/or networks prior to being transmitted to and/or stored on the video data storage 105. For example, in some embodiments, a streaming server, such as a Hypertext Transfer Protocol Live Streaming (HLS) server may stream video data to a video decoding server. The video data may be transmitted from the video decoding server to the video data storage 105.

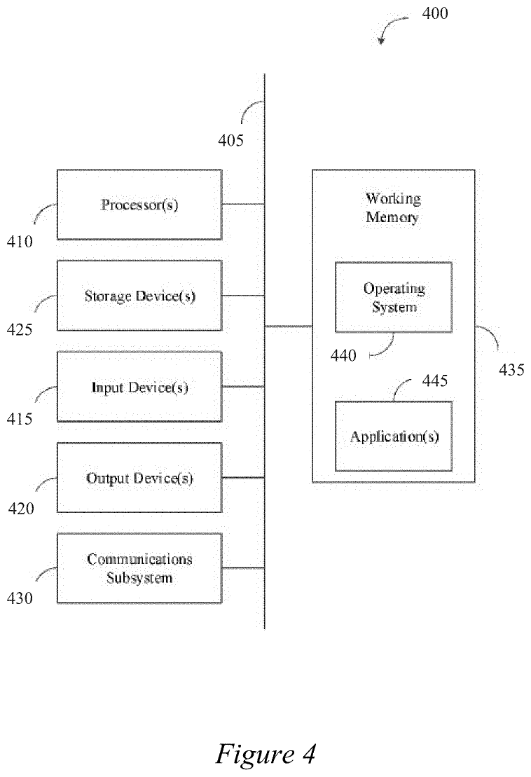

In some embodiments, the video processor 110 may include one or more local and/or remote servers that may be used to perform data processing on videos stored in the video data storage 105. In some embodiments, the video processor 110 may execute one more algorithms on one or more video files stored with the video storage location. In some embodiments, the video processor 110 may execute a plurality of algorithms in parallel on a plurality of video files stored within the video data storage 105. In some embodiments, the video processor 110 may include a processor associated with one or more “edge devices.” For example, in some embodiments, the video processor 110 may be associated with a virtual network adapter, a router, or other edge devices. In some embodiments, the video processor 110 may include a processor associated with a camera, such as one of the cameras 120, 121, and 122, a cellular telephone, a smartphone, a tablet computer, or any other computing device. In some embodiments, the video processor 110 may include a plurality of processors (or servers) that each execute one or more algorithms on one or more video files stored in video data storage 105. Alternatively or additionally, in some embodiments, the video processor 110 may execute one or more algorithms on one or more images from the one or more video files stored in video data storage 105. In some embodiments, the video processor 110 may include one or more of the components of computational system 400 shown in FIG. 4.

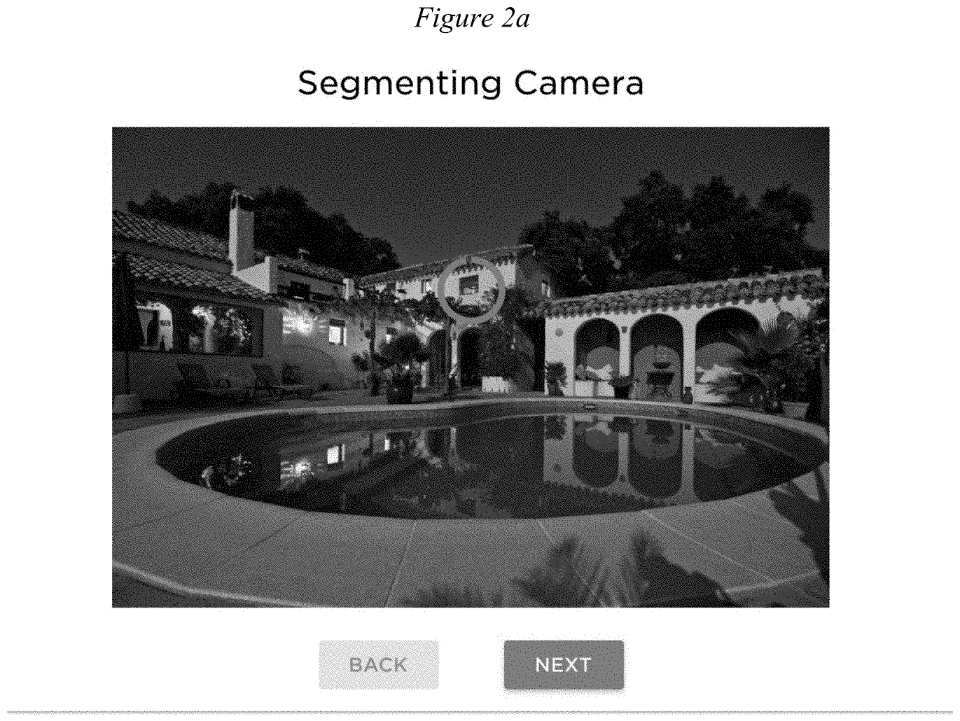

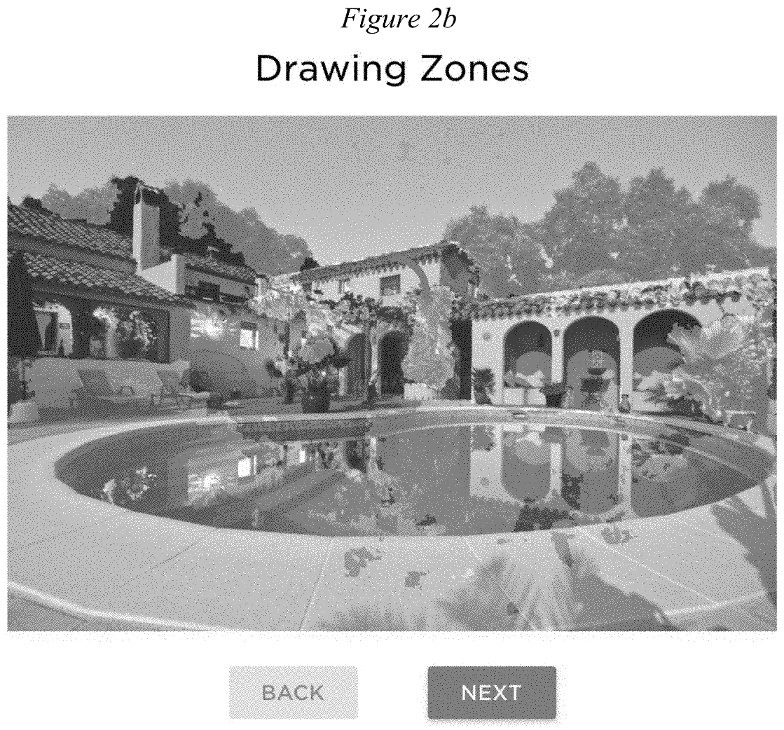

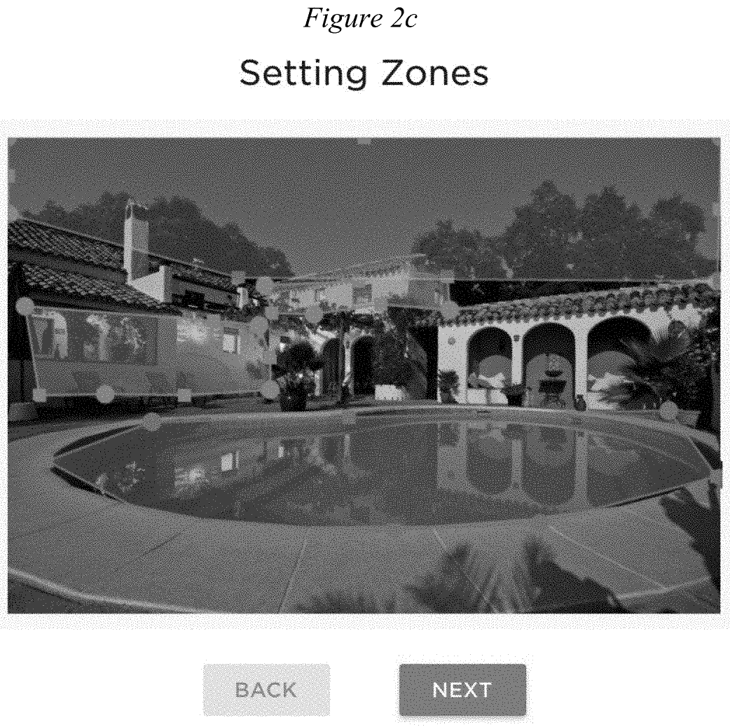

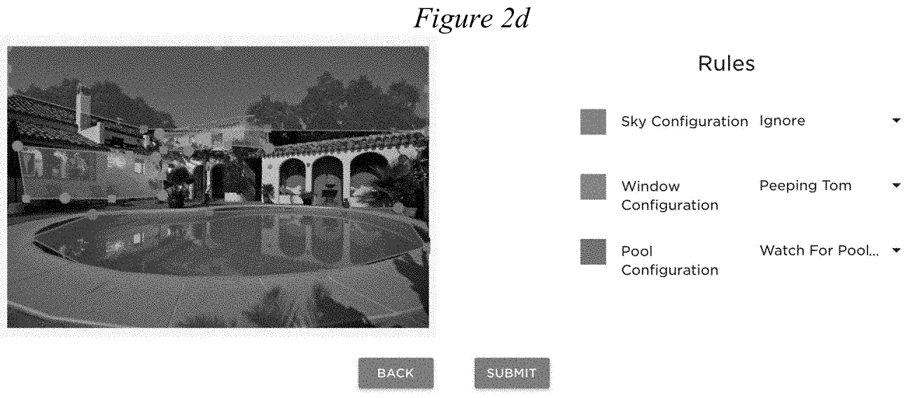

FIG. 2a illustrates an example original image prior to segmentation. In some embodiments, the image 200 may be one image in a video feed, such as one image in a video feed of a security camera 120. In some embodiments, the image 200 may be an image taken from a traditional still camera 121. In some embodiments, the image 200 may be a video feed of a security camera 120. In some embodiments, the image 200 may include many different elements, such as water, vegetation, domiciles, the sky, etc. For example, the image 200 may include a pool, various trees, the sky, a home with various windows, and other elements.

FIG. 2b illustrates an example segmentation discernment map of the original image. A video processor, such as the video processor 110 of FIG. 1, may correlate different portions of the image 200 with different features that may be found in an image. For example, in some embodiments, the image 200 may include a home, a door, a door knob, a window, vegetation such as trees and bushes, the sky, a pool, and other areas. The video processor 110 may determine that certain areas are associated with a home and may create a segment of the original image that contains the elements associated with a home. For example, in some embodiments, the video processor 110 may determine that a door is associated with the home. In some embodiments, the video processor 110 may determine that a window is associated with the home. In some embodiments, the video processor 110 may determine that certain areas are associated with a business environment, such as a retail establishment. For example, areas associated with a retail establishment may include an entrance, a warehouse, checkout lines, cash registers, product demonstration areas, shelving, dressing rooms, and other areas. In some embodiments, the video processor 110 may determine that certain elements are associated with a body of water such as, for example, a pool. In some embodiments, certain elements of the image may be determined to be associated with the sky, vegetation, buildings, roads, or other types of areas.

FIG. 2c illustrates an example segmentation creation map of the original image. After a video processor, such as the video processor 110 of FIG. 1, has associated various elements of the original image 200 with potential categories of interest, the video processor 110 may define segments or zones in the original image 200. For example, the video processor 110 may create a “pool” zone around the pool of the original image 200. Alternatively or additionally, the video processor 110 may create a “window” zone around the windows of the home. Alternatively or additionally, the video processor 110 may create a “door” zone around one or more doors of the home. Alternatively or additionally, the video processor 110 may create a “sky” zone encompassing the area above the roof of the home. In some embodiments, certain areas of the image may not be in any zones. In some embodiments, certain areas of the image may be in multiple zones.

FIG. 2d illustrates an example rule assignment table between the zones of the original image and rules that may be applied to each zone. In some embodiments, a rule may be a set of conditions that may trigger some action in response to the fulfillment of the set of conditions. The response actions may include “ignore,” “warn,” “alert,” “alert by dwelling strangers,” “alert by picking up packages,” etc. In some embodiments, the rule condition may include a “tripwire.” A tripwire in a rule condition may be similar to a physical tripwire or a laser tripwire. The tripwire may be a line or curve in the zone. The tripwire condition may be satisfied if an object or person crosses the tripwire. In some embodiments, the tripwire condition may include a directional component. For example, in some embodiments, the tripwire condition may be satisfied if an object or person crosses the tripwire in a certain direction. In some embodiments, the tripwire condition may be satisfied if a particular object or person crosses the tripwire or if an object or person of a particular type crosses the tripwire. For example, in some embodiments, the tripwire condition may be satisfied if a car crosses the tripwire. Alternatively or additionally, in some embodiments, the tripwire condition may be satisfied if an animal crosses the tripwire.

In some embodiments, the rule condition may include a region or area. A region in a rule condition may involve a two-dimensional section of the zone or may include the entire zone. In some embodiments, a region rule condition may be satisfied if an object or person enters the region and remains in the region for a period of time. For example, a rule may be a condition of movement within a region. Alternatively or additionally, a rule may be a condition of movement of an object of a specific size within a region. For example, a rule may have a condition that is satisfied when a human enters a region. As another example, a rule may have a condition that is satisfied when multiple automobiles enter a region. As an additional example, a rule may have a condition that is satisfied when an animal enters a region and remains in the region for a period of time. In addition, a rule may have a condition that is satisfied when a particular human enters a region.

In some embodiments, the rule condition may include a time element. For example, in some embodiments, a rule may be active during certain times of the day, during certain days of the week, or during certain months of the year. Alternatively or additionally, in some embodiments, a rule may include different conditions depending on the time of the day. For example, in some embodiments, a rule may be active during night but not during the day. For example, a rule condition for a zone around the entrance to a business may have as a condition that a triggering event occurs after business hours, such as between 7 pm and 7 am. As an additional example, in some embodiments, a “door” zone of a residence may include a rule condition to detect when individuals are entering the door during the time when individuals are not expected to enter the door, such as between 8 am and 3 pm during a weekday when children may be at school and parents may be at work. As an additional example, in some embodiments, a “yard” zone may include a rule condition to identify wild animals in the zone between 6 pm and 6 am. The “yard” zone may also include a rule condition to identify humans are present in the zone between 8 am and 5 pm. In these and other embodiments, rule conditions may overlap in time.

In some embodiments, rule conditions may not be associated with a particular zone. In these and other embodiments, a rule condition may be associated with video information from the video feed. For example, in some embodiments, the video processor may be configured to identify looping in the video feed. Alternatively or additionally, in some embodiments, the video processor may be configured to identify tampering with the video feed, an obstructed view in the video feed, abrupt-motion in the video feed, or other tamper events.

In some embodiments, a rule condition may be associated with identified actions by an object. For example, in some embodiments, a rule condition may be associated with the action of a human such as jumping over a fence, punching another human, breaking into a business, or other actions. Alternatively or additionally, in some embodiments, a rule condition may be associated with the action of animals or vehicles, such as a dog barking, a dog chasing an object, a vehicle speeding, a vehicle parking illegally, or any other action.

In some embodiments, rule conditions may be associated with particular characteristics of humans or other objects. For example, in some embodiments, a rule condition may be associated with identifying that a human is wearing a mask or glasses. Alternatively or additionally, in some embodiments, a rule condition may be associated with recognizing a previously unrecognized automobile or human.

In some embodiments, rule conditions may also include information from one or more other sensors. For example, in some embodiments, rule conditions may include sound conditions, temperature conditions, motion conditions, smoke conditions, or other conditions based on sensor data.

In some embodiments, rules may be temporarily disabled or temporarily enabled for short periods of time. For example, in some embodiments, rules may be enabled or disabled for a period of time of one minute, five minutes, fifteen minutes, or any other duration of time. For example, in some embodiments, a parcel delivery person may be expected to arrive at a home at a particular time. A rule may be associated with people approaching a door of the home. The rule may be temporarily disabled during a window of time around the expected arrival time of the parcel delivery person. For example, the rule may be disabled from fifteen minutes prior to the expected delivery time to fifteen minutes after the expected delivery time. Alternatively or additionally, in some embodiments, a rule may be temporarily enabled or disabled in response to an event occurring in the video frame. For example, if an emergency situation is detected in the video frame, particular rules associated with the video feed may be temporarily disabled while the emergency situation is in progress.

In these and other embodiments, a rule may have multiple actions taken in response to fulfillment of the rule condition. For example, a rule may state that a message will be sent upon fulfillment of the condition. As another example, a rule may state that emergency services, such as a police department, a fire department, or an ambulance, be contacted in response to fulfillment of the condition. As another example, a rule may state that an alarm be triggered in response to fulfillment of the condition. Alternatively or additionally, other actions may be taken in response to fulfillment of a rule condition such as querying of a database, storing data in a database, initiating recording of the video stream, turning on lights in an area, locking doors and/or windows in an area, identifying individuals in the zone, and/or any other action.

For example, in some embodiments a user may not be concerned with changes that occur in a video stream within the “sky” zone. Thus, in some embodiments, an “ignore” rule may be assigned to the “sky” zone, which may be used in a further algorithm to ignore changes that may occur or motion that may occur in the “sky” zone. Alternatively or additionally, in some embodiments, the user may be interested in activities that are taking place above a certain object. In these and other embodiments, the user may be concerned with the motion of objects of a certain size in the “sky” zone.

In some embodiments, a user may be concerned with the stationary presence of individuals inside the “window” zone. For example, a user may be concerned with a Peeping Tom lingering nearby the windows of the user's home. A “Peeping Tom” rule may be assigned to the “window” zone. The “Peeping Tom” rule may be conditioned on the stationary presence of a human inside the “window” zone for a preset period of time or a period of time determined by the user. Additionally, in some embodiments, the “Peeping Tom” rule may be conditioned on a time of the day such as between 9 pm and 7 am. For example, in some embodiments, the “Peeping Tom” rule may be fulfilled when a human is present inside the zone for one minute and is not moving. Alternatively or additionally, any duration of time may be used for the “Peeping Tom” rule, such as two minutes, three minutes, or thirty seconds. As a result of the fulfillment of the condition of the “Peeping Tom” rule, a message may be sent to a user, a security company, or a police department. Alternatively or additionally, exterior and/or interior lighting of the location may be turned on in response to fulfillment of the rule condition. Alternatively or additionally, a signal may be sent to any other device, such as any device connected to the camera via a system such as the Internet of Things.

In some embodiments, a user may be interested with activity occurring inside the “pool” zone. For example, an individual may want to know whenever an object enters or leaves from the “pool” zone. The “pool” zone rule may have a condition that is fulfilled whenever a human enters the “pool” zone. Alternatively or additionally, the “pool” zone rule may have a condition that is fulfilled whenever any object enters the “pool” zone. As a result of fulfillment of the “pool” zone rule, a message may be sent to a user, an alarm may be triggered, a message may be sent to a security company, and/or any other action may be taken.

In some embodiments, rules may be associated with events that a user is expecting to occur. For example, in some embodiments a segment may be created around a user's door. A rule may be associated with the zone to determine when a package is left by the door. In some embodiments, a user may be interested in the recurrence of events in a particular zone.

For example, in instances where the system and methods described herein are implemented at a bank, the bank may be interested in individuals that enter the bank on multiple occasions without engaging in any transactions at the bank. A security camera may be positioned such that it records a video stream of the front of the bank. A rule may be created such that if a particular individual walks in front of the bank multiple times in close succession, multiple databases are queried to identify the individual. For example, a rule may be established to capture the image of every person who is within the zone that does not engage in a transaction at the bank. Upon determining that an individual has been recognized multiple times in a short time period, the rule may result in an action such as querying an FBI database, a local database, social media sites, and/or any other site to discover the name and/or other details about the person.

In some embodiments, rules may be associated with multiple zones. In these and other embodiments, a rule may use conditions associated with multiple cameras or with multiple video files, such as video files from the camera 120 and the camera 121. For example, a rule condition may include an individual walking in front of different cameras in close succession. A first camera, for example the camera 120, may be associated with a first bank. A second camera, for example the camera 121, may be associated with a second bank. In response to a particular individual appearing in a zone for a video feed associated with the first camera and a zone for a video feed associated with the second camera, similar actions as listed previously may be taken.

For example, a first zone may be centered on a door handle. A second zone may be centered on a corner of the door. A rule may be created that may include a condition that is associated with the first zone and a condition that is associated with the second zone. For example, a rule condition of “a person entering the home” may include a detection event in the door handle zone (satisfied, for example, when a person places his or her hand on the door handle) and in the door corner zone (satisfied, for example, when a person places his or her foot inside the open door). By creating a rule that uses conditions from multiple zones, complex actions and/or complex sequences of actions can be used as triggering conditions for rule actions. In the preceding example, the combination of the detection events in both the door handle and the door corner zones may screen out false positive detections of “a person entering the home” when, for example, a person places his or her hand on the door handle but does not open the door or when an animal or a person moves past the door corner but does not use the door handle to enter the home. While the preceding example is described using two zones, rules may include conditions associated with many zones. In these and other embodiments, the layering of zones may include a time component. In some embodiments, the order of the sub-conditions in each zone may be important to the overall rule condition. For example, if there is a detection event in the door corner zone before there is a detection event in the door handle zone, this sequence of events may not be indicative of “a person entering the home.” In addition, if the two detection events are separated by a significant space of time, the detection events may not be indicative of “a person entering the home.” For example, if the detection event in the door handle zone and the detection event in the door corner zone are separated by a week, it may be determined that the condition “a person entering the home” is not satisfied, even though the sub-condition triggering events of a detection event in the door handle zone and a detection event in the door corner zone occurred in the desired order.

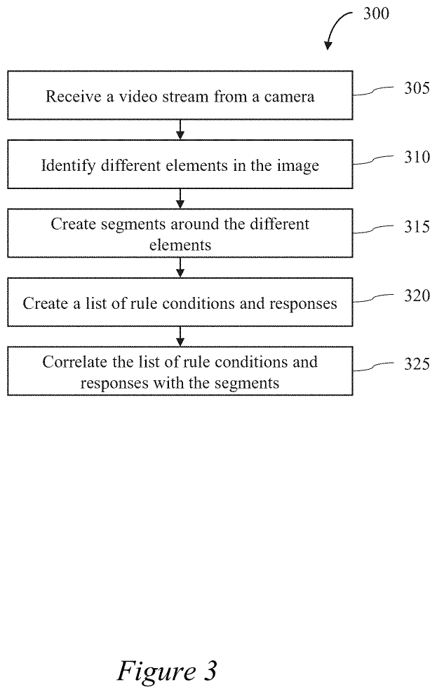

FIG. 3 is a flowchart of an example process 300 for processing images to generate segments and correlating rules with the segments. One or more steps of the process 300 may be implemented, in some embodiments, by one or more components of system 100 of FIG. 1, such as video processor 110. Although illustrated as discrete blocks, various blocks may be divided into additional blocks, combined into fewer blocks, or eliminated, depending on the desired implementation.

Process 300 may begin at block 305. At block 305 the system 100 may receive a video stream from a camera such as, for example, camera 120, camera 121, and/or camera 122. The video stream, for example, may be received as an mjpeg video stream, h264 video stream, VP8 video stream, MP4, FLV, WebM, ASF, ISMA, flash, HTTP Live Streaming, etc. Various other streaming formats and/or protocols may be used. In some embodiment, the video processor 110 may scan the network 115 to identify local cameras that may also be connected to the network 115 such as the camera 120, the camera 121, and/or the camera 122. In these and other embodiments, the video processor 110 may broadcast a request to search for cameras. In these and other embodiments, the video processor 110 may traverse the local network by Internet Protocol addresses to identify cameras. In these and other embodiments, the video processor 110 may search for specific brands of cameras. In some embodiments, the request may search for cameras supporting the ONVIF standard or any other standard. In some embodiments, the system 100 may receive an image snapshot from the identified cameras.

In some embodiments, at block 310 the video processor 110 may identify different elements in the video stream. For example, the video processor 110 may identify elements in a single frame of the video stream and/or may identify elements in multiple frames of the video stream. For example, elements of the video stream associated with the sky may be identified. In some embodiments, elements of the video stream associated with windows, a home, a pool, and/or vegetation may be identified. In some embodiments, processing individual video frames rather than a video clip or video file may be less time consuming and/or less resource demanding. In some embodiments, the elements may be identified based on elements that were identified for other cameras and/or video feeds. In some embodiments, the segments created around the different elements may be updated in response to the view of the video stream from the camera changing. For example, the camera angle of the camera may change over time or the camera may point in a different direction. For example, in some embodiments, the camera may swivel or rotate between different locations. Alternatively or additionally, the camera may be remotely positioned to face a different direction or to point at a different angle. In these and other embodiments, different elements in the image may be identified as changes in the camera view are detected. Additionally, segments created around the different elements may change as changes in the camera view are detected. In these and other embodiments, the segments created may change even if the elements in the image remain unchanged as the camera view changes.

At block 315 segments may be created around the different elements identified at block 310. In some embodiments, segments may not be created around some elements identified at block 310. Alternatively or additionally, in some embodiments multiple segments may include at least one element identified at block 310 in common. In some embodiments, the combination of all of the segments created may not cover the entire video stream and/or the entire image of the video stream. In some embodiments, some of the segments created may overlap. Video processor 110 may create segments around the different elements. In some embodiments, segments may be created based on segments that were created for other cameras and/or video feeds.

In some embodiments, the video processor 110 may identify a different algorithm for each segment. The algorithm for each segment may be configured to identify objects of interest in the segment. Additionally or alternatively, the algorithm for each segment may be adapted to efficiently analyze the video for each segment. In some embodiments, the algorithm identified for each segment may be based on a database of segments and algorithms. For example, in some embodiments, the video processor 110 may store a description of a segment together with an algorithm that is used with that segment. After creating a new segment, the video processor 110 may compare the new segment with the segments previously stored in the database. Based on the comparison of the new segment with the segments previously stored in the database, the video processor 110 may select an algorithm that corresponds with a segment that is similar to the new segment. The similarity of segments may be determined by evaluating a scene structure and a camera view in the video stream.

In some embodiments, the video streams may be processed as described in conjunction with the images 200a-200d shown in FIG. 2. Various other processing may occur.

In some embodiments, at block 320 a list of rule conditions and responses may be created. For example, a rule condition identifying humans moving into or out of a segment may be created. As another example, a rule condition identifying a human remaining stationary in a segment may be created. Rule responses may also be created. Rule responses may be a set of actions that may be taken if the rule condition is satisfied. For example, a rule response may be sending a message, such as a Short Message Service (SMS) or a Multimedia Messaging Service (MMS) message, to a cell phone, an email message to an email address, and/or sending a message via another messaging platform. As another example, a rule response turning on lights and/or locking a door may be created. For example, a rule with a rule condition identifying whether a human has entered a zone and a corresponding rule response contacting the police may be created. Satisfaction of rule conditions may be determined in various ways, some of which are described herein. Implementation of rule responses may be performed in various ways, some of which are described herein. In some embodiments, the video processor 110 may create the list of rule conditions and responses.

At block 325 the list of rule conditions and responses may be correlated with the segments. For example, each segment may be correlated with one or more rule conditions and rule responses. In some embodiments, a segment may have a single rule condition and multiple rule responses.

In some embodiments, the video processor 110 may correlate the rule conditions and the rule responses with each segment based on the rule conditions and rule responses correlated with similar segments in a database. For example, a database may contain multiple segments from multiple video streams. Each segment may be correlated with multiple rule conditions and rule responses. The video processor 110 may correlate particular rule conditions and the rule responses from the database with the segments created at block 315 based on the similarity between the segments in the database and the segments created at block 315.

In some embodiments, the rule conditions and the rule responses correlated with a segment may be based on the elements in the segment and/or based on the type of the segment. Alternatively or additionally, the correlation of rule conditions and rule responses with segments may be partially based on the location of a camera generating the video stream and/or the type of camera system generating the video stream. For example, segments of a video stream for a home security system may be correlated with different rule conditions and rule responses than segments of a video stream for a bank security system. Alternatively or additionally, in some embodiments a user of the process 300 may select particular rule conditions and/or responses for the segments created at block 315.

In some embodiments, the rule conditions and rule responses for different zones may be interrelated. For example, in some embodiments, a segment may be on a door handle. In these and other embodiments, a different segment may be on a corner of a door associated with the door handle. A rule condition of “a person entering the home” may be created by detecting an event in the door handle segment followed by detecting an event in the door corner segment. Although this example depicts the interaction of two segments, in practice the rule conditions could entail sub-conditions in many different segments. The interaction of sub-conditions in different segments may allow the rule conditions to be precise and detect complex actions and/or a complex series of actions.

In some embodiments, the system 100 may include one or more web servers that may host a website where users can interact with videos stored in the video data storage 105, select videos to view, select videos to monitor using embodiments described in this document, assign or modify segments, search for rule conditions and/or rule responses of interest, select and/or modify the rule conditions and responses associated with each segment, select cameras from which to create segments and correlate rule conditions and responses, etc. In some embodiments, the website may allow a user to select a camera that they wish to monitor. For example, the user may enter the IP address of the camera, a user name, and/or a password. Once a camera has been identified, for example, the website may allow the user to view video and/or images from the camera within a frame or page being presented by the website. As another example, the website may store the video from the camera in the video data storage 105 and/or the video processor 110 may begin processing the video from the camera to identify elements, create segments, create rule conditions and rule responses, etc.

The computational system 400 (or processing unit) illustrated in FIG. 4 can be used to perform and/or control operation of any of the embodiments described herein. For example, the computational system 400 can be used alone or in conjunction with other components. As another example, the computational system 400 can be used to perform any calculation, solve any equation, perform any identification, and/or make any determination described here.

The computational system 400 may include any or all of the hardware elements shown in the figure and described herein. The computational system 400 may include hardware elements that can be electrically coupled via a bus 405 (or may otherwise be in communication, as appropriate). The hardware elements can include one or more processors 410, including, without limitation, one or more general-purpose processors and/or one or more special-purpose processors (such as digital signal processing chips, graphics acceleration chips, and/or the like); one or more input devices 415, which can include, without limitation, a mouse, a keyboard, and/or the like; and one or more output devices 420, which can include, without limitation, a display device, a printer, and/or the like.

The computational system 400 may further include (and/or be in communication with) one or more storage devices 425, which can include, without limitation, local and/or network-accessible storage and/or can include, without limitation, a disk drive, a drive array, an optical storage device, a solid-state storage device, such as random access memory (“RAM”) and/or read-only memory (“ROM”), which can be programmable, flash-updateable, and/or the like. The computational system 400 might also include a communications subsystem 440, which can include, without limitation, a modem, a network card (wireless or wired), an infrared communication device, a wireless communication device, and/or chipset (such as a Bluetooth® device, a 802.6 device, a Wi-Fi device, a WiMAX device, cellular communication facilities, etc.), and/or the like. The communications subsystem 440 may permit data to be exchanged with a network (such as the network described below, to name one example) and/or any other devices described herein. In many embodiments, the computational system 400 will further include a working memory 435, which can include a RAM or ROM device, as described above.

The computational system 400 also can include software elements, shown as being currently located within the working memory 435, including an operating system 440 and/or other code, such as one or more application programs 445, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 425 described above.

In some cases, the storage medium might be incorporated within the computational system 400 or in communication with the computational system 400. In other embodiments, the storage medium might be separate from the computational system 400 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 400 and/or might take the form of source and/or installable code, which, upon compilation and/or installation on the computational system 400 (e.g., using any of a variety of generally available compilers, installation programs, compression/decompression utilities, etc.), then takes the form of executable code.

Various embodiments are disclosed. The various embodiments may be partially or completely combined to produce other embodiments.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing art to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical, electronic, or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for-purposes of example rather than limitation, and does not preclude inclusion of such modifications, variations, and/or additions to the present subject matter as would be readily apparent to one of ordinary skill in the art.

1.-3. (canceled)

4. A method for creating a segments for a video stream and assigning rules to the segments, the method comprising:
receiving a video stream;
selecting one or more video frames from the video stream;
identifying one or more elements of the video stream;
creating one or more segments based on the one or more elements;
creating a list of one or more rule conditions and one or more rule responses;
correlating one or more rule conditions and one or more rule responses with each of the one or more segments;
correlating the one or more rule conditions and the one or more rule responses with one or more different time spans; and
updating zones automatically when a view of the video stream changes.

5. The method of claim 4, wherein receiving the video stream comprises receiving the video stream from a security camera.

6. The method of claim 4, wherein identifying one or more elements and creating one or more segments is performed locally in an artificial intelligence engine at a camera from which the video stream is received.

7. The method of claim 4, further comprising detecting an event in one of the updated zones.

8. The method of claim 4, wherein:
the video stream is obtained from a first camera; and
identifying the one or more elements includes making reference to another element previously identified for another camera.
